(19) United States
(12) Patent Application Publication
(10) Pub. No.: US 2005/0184201 A1
(43) Pub. Date: Aug. 25, 2005

(54) Exhaust system support structure

(75) Inventors: Hideyuki Komitsu, Toyota-shi (JP); Yoshikazu Shimazu, Chiryu-shi (JP); Hideyuki Ishii, Chiryu-shi (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, Toyota-shi (JP)

(21) Appl. No.: 11/044,366

(22) Filed: Jan. 28, 2005

(30) Foreign Application Priority Data
Feb. 6, 2004 (JP) 2004-031122

(51) Int. Cl. F16L 3/00

(52) U.S. Cl. 248/58

(57) ABSTRACT

An exhaust system support structure for supporting an exhaust system on a device main body via a rubber material comprises a support portion connected to the rubber material and a heat shielding portion provided between a member constituting the exhaust system and the support portion so as to define a space. The heat shielding portion is provided such that said support portion is attached to a non-joined portion thereof that is not joined to the member constituting the exhaust system, and so as to be interposed between a connection site at which the rubbermaterial is connected to the support portion, and a site of the member constituting the exhaust system which is closest to the connection site.

### CROSS REFERENCE TO RELATED APPLICATIONS

The present invention claims priority under 35 USC §119 to Japanese Patent Application No. 2004-31122, filed on Feb. 6, 2004. The contents of that application are incorporated herein by reference in their entirety.

### BACKGROUND OF THE INVENTION

1. Field of the Invention

The present invention relates to an exhaust system support structure (a support structure for supporting an exhaust system), such as a structure for supporting an exhaust system which discharges exhaust gas produced in an internal combustion engine provided in a device e.g. a vehicle or the like.

2. Description of the Related Arts

A device disclosed in Japanese Unexamined Patent Application Publication 2000-2113 may be cited as an example of a support structure for supporting an exhaust system provided in a moving device such as a vehicle and comprising a muffler (silencer), an exhaust pipe, and so on, upon the main body of the vehicle or the like. In this exhaust system support structure, a support member is constructed by bent rod-form hangers which are fixed to the rear portion of a muffler along an outer peripheral arc of the end face of the muffler. A pair of rod-form hangers hanging from the lower portion of the vehicle body is provided in series so as to correspond to the hangers that are fixed to the muffler. These corresponding hangers are connected to each other by small cushion rubbers, and thus the exhaust system is supported on the vehicle body.

As described in Japanese Unexamined Patent Application Publication 2000-2113, this conventional exhaust system support structure, constituted as described above, attempts to reduce in the number of components, and hence a reduction in weight, by eliminating a support member in a vibration transmission portion, and also aims to improve the vibration-reduction and noise-reduction ability.

Japanese Unexamined Utility Model Publication H4-54931, discloses a structure in which a hanger bracket having a ceiling wall and a pair of side walls is provided on the surface of an exhaust pipe of an engine, one end of a hanger rod is fixed to an attachment groove in the hanger bracket, and the other end of the hanger rod is connected to the vehicle body via a mount formed from rubber or the like. The feature of this structure is the attachment groove for attaching the hanger rod to the hanger bracket, enabling the hanger rod to be attached in two directions using the one kind of hanger bracket. The structure also aims to maintain sufficient support rigidity in the hanger bracket.

### SUMMARY OF THE INVENTION

In the exhaust system support structure of Japanese Unexamined Patent Application Publication 2000-2113, however, the support member constructed by the hangers and so on is joined directly to the muffler, and hence the cushion rubber is heated easily by heat transfer from a support member such as a muffler which is heated by exhaust gas and thus becomes a heat source.

Further, the cushion rubber is exposed directly to radiation heat from the muffler or the like, serving as a heat source, further promoting the heating thereof. The main object of providing the cushion rubber is to reduce vibration generated by the exhaust system, and thereby, the material for forming the cushion rubber tends to be a rubber material with an excellent damping characteristic or a vibration attenuating characteristic and heat resistance characteristic. However, the heat resistance temperature thereof is typically slightly less than 150 to 180° C.

The present inventors learned that when a metallic rod-form hanger is welded to a muffler, the cushion rubber is sometimes heated to approximately 200° C. Moreover, when the cushion rubber is heated to the vicinity of its heat resistance temperature, temporal thermal degradation may occur. For example, if the cushion rubber is maintained at a temperature in the vicinity of its heat resistance temperature for approximately one hour, the rubber material loses oil and becomes gradually harder so that it may become unable to support the exhaust system.

In the conventional structure disclosed in Japanese Unexamined Utility Model Publication H4-54931, the hanger rod, having a substantially reverse C-shaped cross section and connected to the exhaust pipe at the side wall end portion thereof, is connected to the exhaust pipe via the hanger bracket, and hence thermal conduction from the exhaust pipe may be alleviated.

According to the drawings of Japanese Unexamined Utility Model Publication H4-54931, however, due to the extending form of the hanger rod, the rubber mount (corresponding to the cushion rubber) which is attached to the other end of the hanger rod is positioned so as to face the site of the pipe directly below or directly to the side of the mount (i.e. in the direct vicinity of the mount). As a result, the rubber mount is heated improperly by direct radiation heat from this pipe site, and the resulting thermal degradation may be impossible to suppress sufficiently.

Particularly in recent years, the component concentration of gas discharged from vehicles and the like has been subjected to severe restrictions in countries all over the world in order to reduce the CO₂ concentration in the environment, and demands are also being made for further improvements in fuel economy. Recently, there has been a trend toward lean fuel combustion as one method of solving these problems, and as a result, the temperature of exhaust gas emitted from internal combustion engines has been rising gradually. Accordingly, the members constituting an exhaust system, such as a muffler, are heated to ever greater temperatures, creating an urgent need for measures to prevent degradation (thermal degradation) of cushion rubbers caused by this thermal effect.

In view of such circumstances, it is an object of the present invention to provide an exhaust system support structure that is capable of suppressing the heating of a rubber material used as a cushioning member to a sufficiently greater degree than is possible in a conventional support structure, thus preventing thermal degradation of the rubber material sufficiently.

To solve the problems described above, an exhaust system support structure according to the present invention serves to support an exhaust system which discharges combustion gas on the main body of a device such as a vehicle via a rubber material used as a cushioning member (a member for reducing shock or vibration).

This exhaust system support structure comprises a support portion connected to the rubber material, and a heat shielding portion provided between a member (or component; to be referred to as “exhaust system constitutional member” hereafter) constituting the exhaust system and the support portion so as to define a space. The heat shielding portion is provided such that the support portion is attached to a non-joined portion thereof that is not joined to the exhaust system constitutional member, and so as to be interposed between a connection site at which the rubber material is connected to the support portion, and a site of the exhaust system constitutional member which is closest to the connection site.

In the exhaust system support structure constituted as described above, by providing the heat shielding portion, a space functioning as a heat shielding layer is defined between the exhaust system constitutional member and the support portion when the exhaust system is connected to the device main body. Further, since the support portion is attached to the non-joined portion of the heat shielding portion that is not joined to the exhaust system constitutional member, the heat of the exhaust system constitutional member is conducted to the support portion indirectly through the heat shielding portion. As a result, the amount of heat traveling to the rubber material connected to the support portion is reduced dramatically in comparison with a case in which the support portion is joined directly to the exhaust system constitutional member.

Moreover, since the heat shielding portion is interposed between the connection site at which the rubber material is connected to the support portion, and the site of the exhaust system constitutional member which is closest to the connection site, the site of the exhaust system constitutional member positioned closest to the rubber material connected to the support portion is covered by the heat shielding portion when seen from at least a part of the rubber material, preferably as large a part of the rubber material as possible, and more preferably all of the rubber material. Therefore, radiation heat that is emitted toward the rubber material from the site of the exhaust system constitutional member, which serves as the main heat source of the rubber material, is blocked sufficiently, thereby dramatically reducing temperature rise in the rubber material due to the effect of the radiation heat.

To limit heat flow (heat flux) from the exhaust system constitutional member to the support portion as much as possible, it is effective to make the joint area between the exhaust system constitutional member and the heat shielding portion, the cross sectional area of the members constituting the heat shielding portion, and the joint area between the support portion and the heat shielding portion as small as possible.

Note, however, that in order to realize sufficient strength to support the exhaust system on the device main body, the dimensions and form of the heat shielding portion and support portion, as well as the aforementioned joint areas and member cross sectional areas, are preferably set appropriately.

Further, as noted above, the heat shielding portion is preferably provided so as to block radiation heat from the closest exhaust system constitutional member over the entire area of the rubber material. In other words, it is extremely beneficial if the heat shielding portion is provided such that when the contour of the rubber material is projected onto the closest exhaust system constitutional member, the entire resulting projected image is included within the range of the heat shielding portion.

If necessary, the heat shielding portion and/or the support portion may also be provided with a member for promoting cooling by means of heat dissipation such as a heat-dissipating fan.

Specifically, the heat shielding portion preferably takes a substantial plate form with a recessed portion, and at least a part of a peripheral edge portion of the recessed portion is preferably joined to the exhaust system constitutional member. A specific example of the form of the heat shielding portion in this case is a form with a reverse C-shaped cross section, a form with a U-shaped cross section, a tubular form having one closed end, such as a bowl-form, or a cup form.

In so doing, the pre-formed recessed portion in the heat shielding portion enables the space functioning as the aforementioned heat shielding layer to be defined easily. Further, since the heat shielding portion is joined to the exhaust system constitutional member by at least a part of the peripheral edge portion of the recessed portion, the space functioning as the heat shielding layer is defined securely.

By appropriately adjusting the length or area of the joint between the peripheral edge portion of the recessed portion and the exhaust system constitutional member, the amount of heat transfer from the exhaust system constitutional member to the support portion can be controlled as desired while maintaining sufficient strength to support the exhaust system.

Note that the term “substantial plate form” in relation to the heat shielding portion includes not only an aspect in which the heat shielding portion is formed as a member having an entirely closed surface, but also an aspect in which the member surface is partially open, for example an aspect in which a plurality of strip-form members are provided side by side at fixed intervals, such as a grate form, an aspect in which narrower members (including linear members) are woven into mesh form, and so on.

The support portion also preferably takes a bent rod form, one end portion of which is joined along an outer wall of the heat shielding portion, and the other end portion of which is connected to the rubber material.

In this case, heat transfer from the heat shielding portion to the support portion, and heat transfer from the support portion to the rubber material, can be suppressed easily while maintaining sufficient joining strength between the heat shielding portion and the support portion.

The present invention is particularly beneficial when the member constituting the exhaust system is a muffler or an exhaust pipe, and in particular a muffler and exhaust pipe (including a manifold) constituting an exhaust system provided in a vehicle such as an automobile, which is capable of reaching a high temperature of approximately 200° C. in certain cases, as described above.

According to the exhaust system support structure of the present invention, a heat shielding portion is provided between an exhaust system constitutional member which reaches high temperatures and a support portion, thereby defining a space which functions as a heat shielding layer. Consequently, heating of a rubber material caused by heat transfer and radiation heat from the exhaust system constitutional member can be suppressed dramatically in comparison with a conventional structure, enabling heat degradation of the rubber material to be prevented sufficiently.

### BRIEF DESCRIPTION OF DRAWINGS

FIG. 1 is a schematic view showing an example of a preferred embodiment of an exhaust system support structure according to the present invention, in which the exhaust system support structure is attached to a muffler provided in an exhaust system;

FIG. 2 is a sectional view schematically showing the main parts of a cross section of FIG. 1, severed along a II-II line in FIG. 1; and

FIG. 3 is a configurational view schematically showing an example of another preferred embodiment of the exhaust system support structure according to the present invention, in which the exhaust system support structure is attached to an exhaust pipe provided in the exhaust system.

### DETAILED DESCRIPTION OF THE INVENTION

Embodiments of the present invention will be described in detail below. Note that positional relationships such as above and below, or to the left and right, are assumed to be based on the positional relationships shown in the drawings unless indicated specifically to be otherwise. Further, the dimensional proportions in the drawings are not limited to those illustrated in the drawings.

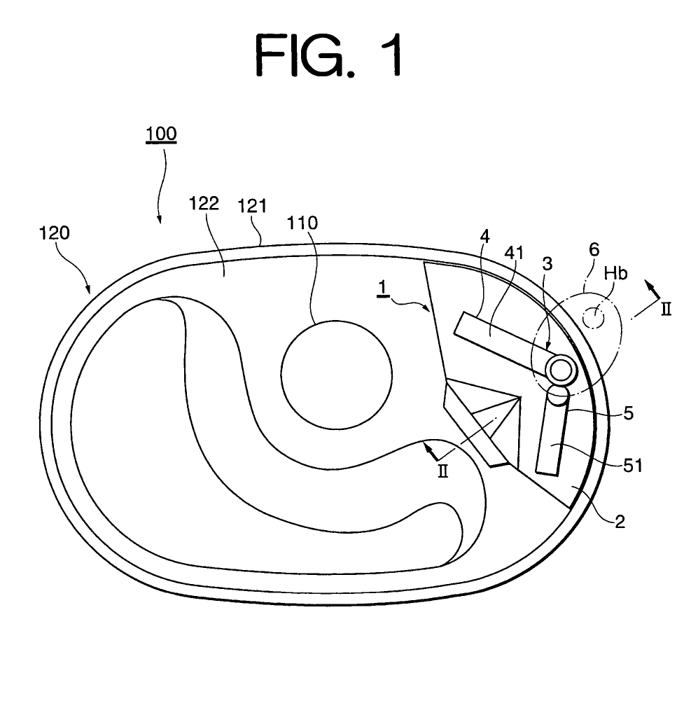

FIG. 1 is a schematic view showing an example of a preferred embodiment of an exhaust system support structure according to the present invention, in which the exhaust system support structure is attached to a muffler provided in an exhaust system, and is also a front view thereof seen from the direction of extension of the exhaust system.

Exhaust system 100 shown in the drawing is constituted such that main muffler 120 is connected to an exhaust manifold (not shown), which is attached to a cylinder head of an internal combustion engine, via exhaust pipe 110 such as a front pipe and/or a center pipe, and such that a sub-muffler (not shown) is connected to the rear end of main muffler 120 via an exhaust pipe such as a center pipe and/or a tail pipe (not shown). Main muffler 120 (an exhaust system constitutional member) is constituted such that both open ends of drum portion 121 having a tubular form with a substantially elliptical cross section are blocked by end wall 122, and such that support structure 1 (an exhaust system support structure) is provided in a predetermined site on end wall 122.

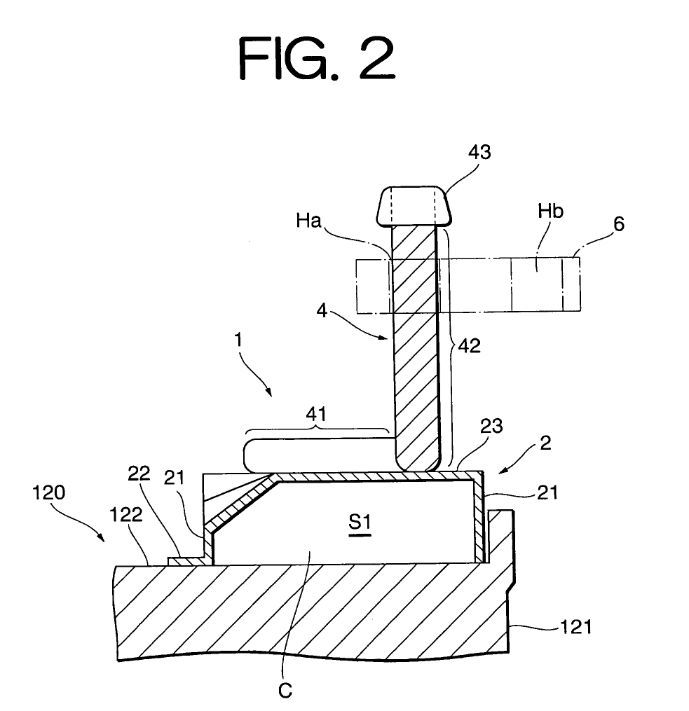

FIG. 2 is a sectional view schematically showing the main parts of a cross section of FIG. 1, severed along a II-II line in FIG. 1. Support structure 1 is constituted by heat shield plate 2 (heat shielding portion) and support 3. Heat shield plate 2 takes a bowl form (cup form) with a substantially fan-shaped plane, and comprises recessed portion C. Heat shield plate 2 is joined to main muffler 120 such that the open end thereof faces end wall 122 face of main muffler 120, or in other words such that the end of side wall 21 and joining seam 22 of heat shield plate 2, corresponding to a peripheral edge portion of recessed portion C, contact the surface of end wall 122. Thus adiabatic space S1 (a space) is defined by heat shield plate 2 and end wall 122 of main muffler 120.

Support 3 is constituted by main rod 4 (support portion) and auxiliary rod 5 (see FIG. 1). Main rod 4 is formed as a rod-form member having a substantially L-shaped form (see FIG. 2). More specifically, main rod 4 comprises joined portion 41 (one end portion) which is joined to the surface of upper wall 23 (non-joined portion) of heat shield plate 2 so as to extend along upper wall 23, protruding portion 42 (other end portion) which bends from one end of joined portion 41 to extend in a substantially perpendicular direction to the surface of upper wall 23, and stopper portion 43 provided on the tip end of protruding portion 42.

Meanwhile, auxiliary rod 5 takes a similar form to main rod 4, but does not comprise stopper portion 43. More specifically, joined portion 51 extending along upper wall 23 of heat shield plate 2 is joined to the surface of upper wall 23. A protruding site (protruding portion) which bends from joined portion 51 of auxiliary rod 5 is shorter than protruding portion 42 of main rod 4, and is joined to a side wall of protruding portion 42.

Main muffler 120 equipped with support structure 1 thus constituted is supported on a vehicle main body (not shown) in the following manner, for example. Protruding portion 42 of main rod 4 is fitted into, and thus fixed to, hole portion Ha of a substantially plate-form support rubber 6 (rubber material), shown by the dot-dash line in the drawing. Another hole portion Hb is pierced through support rubber 6, and an appropriate rod-form member joined to the vehicle main body is fitted into, and thus fixed to, this hole portion Hb. As a result, main muffler 120 is connected to and supported on the vehicle main body.

As described above, exhaust system 100 is typically an elongated member formed by arranging in series exhaust pipes such as a front pipe, a center pipe, and a tail pipe, and components such as an auxiliary muffler. By providing an exhaust system support structure such as support structure 1 according to the present invention in sites other than main muffler 120 where necessary, the entire exhaust system 100 can be supported on the vehicle main body securely.

When exhaust system 100 equipped with support structure 1 is supported on the vehicle main body in the manner described above, heat shield plate 2 is joined onto end wall 122 of main muffler 120, thereby defining adiabatic space S1, and hence it becomes extremely difficult for heat from main muffler 120 to be conducted to main rod 4 and auxiliary rod 5, which are joined to upper wall 23 serving as the non-joined portion of heat shield plate 2.

Therefore, even if exhaust system 100 is raised to a high temperature by exhaust gas produced when the vehicle or the like is operated, heating of main rod 4 can be suppressed to a much greater degree than in a conventional structure, where the support member is joined directly to the exhaust system constitutional members. As a result, the amount of heat traveling to support rubber 6 is reduced sufficiently for thermal degradation of support rubber 6, caused by heat input into support rubber 6, to be prevented.

Further, since upper wall 23 of heat shield plate 2 is interposed between the site at that support rubber 6 is connected to protruding portion 42 of the main rod 4 and the site of main muffler 120 (the site above end wall 122), shown directly below the former site in the drawing, the site at which end wall 122 of main muffler 120 is closest to support rubber 6 is covered by heat shield plate 2. Accordingly, radiation heat traveling from this site to support rubber 6 is blocked by heat shield plate 2. As a result, the amount of heat traveling to support rubber 6 due to radiation from end wall 122 can be reduced dramatically, further preventing thermal degradation of support rubber 6.

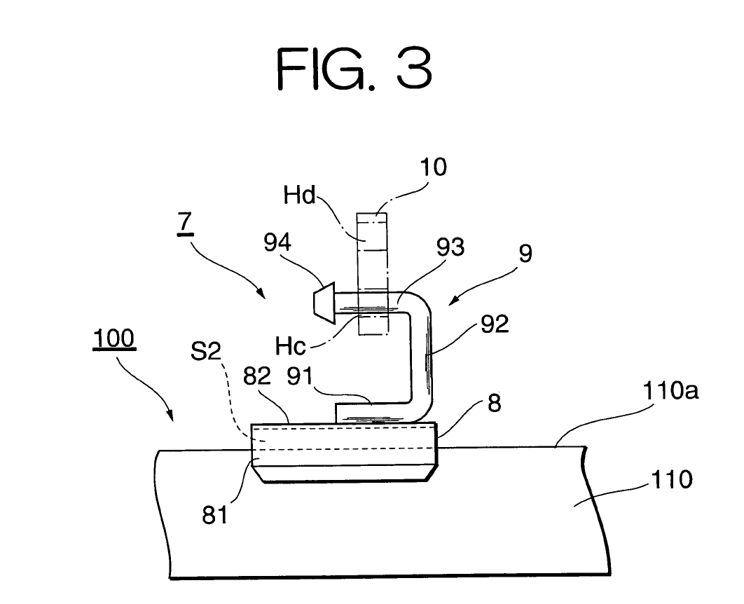

FIG. 3 is a configurational view schematically showing an example of another preferred embodiment of the exhaust system support structure according to the present invention, in which the exhaust system support structure is attached to an exhaust pipe provided in the exhaust system. FIG. 3 is also a side view seen from a perpendicular direction to the extension direction of exhaust system 100.

Support structure 7 (an exhaust system support structure) is attached to a pipe wall of exhaust pipe 110 such as a center pipe, and constituted by heat shield plate 8 (heat shielding portion) and support rod 9 (support portion). Heat shield plate 8 takes a form with a substantially reverse C-shaped cross section, and comprises side wall 81 having an end portion which abuts against, and is thus fixed to, pipe wall 110a of exhaust pipe 110. Thus adiabatic space S2 (a space) is defined by upper wall 82 of heat shield plate 8 and pipe wall 110a of exhaust pipe 110.

Support rod 9 is formed as a rod-form member having a substantially reverse C shape. More specifically, support rod 9 comprises joined portion 91 (one end portion) which is joined to the surface of upper wall 82 (non-joined portion) of heat shield plate 8 so as to extend along upper wall 82, and first protruding portion 92 which bends from one end of joined portion 91 to extend in a direction a way from exhaust pipe 110. Second protruding portion 93 (other end portion) bends away from one end of first protruding portion 92 so as to extend in a substantially perpendicular direction to the extension direction of first protruding portion 92, and stopper portion 94 is provided on the tip end of second protruding portion 93.

Exhaust pipe 110 equipped with support structure 7 thus constituted is supported on a vehicle main body (not shown) in the following manner, for example.

Protruding portion 93 of support rod 9 is fitted into, and thus fixed to, hole portion Hc of a substantially plate-form support rubber 10 (rubber material), shown by the dot-dash line in the drawing. Another hole portion Hd is pierced through support rubber 10 in a similar manner to support rubber 6, and an appropriate rod-form member joined to the vehicle main body is fitted into, and thus fixed to, this hole portion Hd. As a result, exhaust pipe 110 is connected to and supported on the vehicle main body.

When support structure 7 is attached to exhaust pipe 110 in this manner, heat degradation of support rubber 10 can be suppressed in a similar manner to the case in which support structure 1 shown in FIGS. 1 and 2 is attached to main muffler 120. In other words, by defining adiabatic space S2, the amount of heat transfer from exhaust pipe 110 to the support rod can be reduced dramatically such that the amount of heat traveling to support rubber 10 is reduced sufficiently. Consequently, heat degradation due to heat input into support rubber 10 can be suppressed sufficiently.

Further, since upper wall 82 of heat shield plate 8 is interposed between the site at which support rubber 10 is connected to second protruding portion 93 of support rod 9 and the site on pipe wall 110a directly below (closest to) the former site in the drawing, radiation heat traveling from exhaust pipe 110 to support rubber 10 is blocked by heat shield plate 8. Consequently, the amount of heat traveling to support rubber 10 due to radiation can be reduced dramatically, further preventing thermal degradation of support rubber 10.

Particularly in this embodiment, when the contour of support rubber 10 is projected onto pipe wall 110a which is closest thereto, the entire resulting projected image can be projected on upper wall 82 of heat shield plate 8. Hence, heat input caused by radiation traveling to support rubber 10 can be suppressed even further.

Note that the present invention is not limited to the embodiments described above, and may be modified in various ways within the scope thereof. For example, when the exhaust system support structure according to the present invention supports an exhaust system via a rubber material, the support structure may be employed in a desired site of the exhaust system, but even when a rubber material is not used, the exhaust system support structure according to the present invention may be used to support an exhaust system on a device main body via another cushioning material (a damping member, vibration-reducing member, buffering member, and so on) that is susceptible to heat degradation similarly to the rubber material.

The entire surface of heat shield plate 2, 8 does not have to be blockaded, and may take a partially open form such as a grate form or a mesh form. Needless to say, support 3 and support rod 9 are not limited to a rod form. If necessary, heat shield plate 2, 8 and/or support 3 or support rod 9 may also be provided with a member for promoting cooling through heat dissipation, such as a heat-dissipating fan. Furthermore, there are no particular limitations on the height (thickness as a heat shielding layer) of adiabatic spaces S1 and/or S2, and although this height depends on the power source temperature, the heat-resistance temperature of the rubber material, and so on, when the exhaust system support structure is applied to an automobile, the height is preferably set at approximately several millimeters to several tens of millimeters, for example, in order to obtain a favorable heat transfer and radiation heat shielding effect while maintaining strength.

The exhaust system support structure according to the present invention is capable of suppressing heating of a rubber material used as a cushioning material to a sufficiently greater degree than a conventional support structure, and is thus able to prevent thermal degradation of the rubber material sufficiently. Hence this exhaust system support structure may be used widely in devices, moving devices, equipment, and so on such as a vehicle comprising an exhaust system and the like connected to an internal combustion engine.

1. An exhaust system support structure for supporting an exhaust system on a device main body via a rubber material, comprising:
a support portion connected to said rubber material; and
a heat shielding portion provided between a member constituting said exhaust system and said support portion so as to define a space,
wherein said heat shielding portion is provided such that said support portion is attached to a non-joined portion thereof that is not joined to said member constituting said exhaust system, and so as to be interposed between a connection site at which said rubber material is connected to said support portion, and a site of said member constituting said exhaust system which is closest to said connection site.

2. The exhaust system support structure according to claim 1, wherein said heat shielding portion takes a substantial plate form with a recessed portion, and at least a part of a peripheral edge portion of said recessed portion is joined to said member constituting said exhaust system.

3. The exhaust system support structure according to claim 1, wherein said support portion takes a bent rod form, one end portion of which is joined along an outer wall of said heat shielding portion, and another end portion of which is connected to said rubber material.

4. The exhaust system support structure according to claim 1, wherein said member constituting said exhaust system is a muffler or an exhaust pipe.
